(19) United States
(12) Patent Application Publication
(10) Pub. No.: US 2013/0037666 A1
(43) Pub. Date: Feb. 14, 2013

(54) CHANNEL LOCK FILTER FASTENING SYSTEM FOR USE WITH AN AIR INTAKE STRUCTURE

(71) Applicant: Randy Simmons, West Chester, OH (US)

(72) Inventor: Randy Simmons, West Chester, OH (US)

(21) Appl. No.: 13/205,908

(22) Filed: Aug. 9, 2011

(51) Int. Cl. F16M 13/02

(52) U.S. Cl. 248/220.31

(57) ABSTRACT

A fastening system for applying, over an intake opening and surrounding fascia of a structure, a filter screen exhibiting a reinforced extending perimeter within which is configured a plurality of grommets. Any number of elongated rails are provided and which are adapted to being secured to the fascia at locations surrounding the intake opening, such including a first horizontally (upper and lower) extending pair alone or in combination with a second vertical side extending pair. Each of the rails exhibits a three dimensional cross sectional shape with a forwardly projecting support surface within which is configured an outwardly facing narrowed slot. A plurality of bolt head fasteners are successively installable through an accessible end location of the rail and are traversable along an interior channel. A threaded shaft of each bolt fastener projects through the outwardly facing slot and, upon the grommets aligning with and seating over the projecting shafts, a plurality of nuts are tightened upon the exposed shafts in order to affix the filter.

### FIELD OF THE INVENTION

The present invention is directed to an assembly for securing a filter screen to a perimeter extending face surrounding a central opening of an air intake structure. More specifically, the present invention discloses a channel lock construction including any number (such as two to four) modified “U” cross sectional shaped rails which secure in generally parallel extending fashion to the edges of the intake opening. A plurality of bolt head fasteners are slidably installed within accessible open end channels of the “U” shaped rails, such that their threaded shafts project through a narrowed and lengthwise extending slot opening defined in each rail. The attachable filter screen exhibits a reinforced perimeter within which is configured a plurality of edge proximate and extending grommets through which the bolt shafts project. Wing nuts are provided for securing over the projecting ends of the threaded shafts and, in combination with vinyl coatings in the wing nut internal threads or separately applied lock washers, retain the screen in installed fashion against the intake face and around the opening.

### BACKGROUND OF THE INVENTION

Filter screen assemblies, such as utilized for covering an intake opening associated with an air handling unit, are known. Such screens are usually either affixed to the surrounding fascia extending around a perimeter of the intake opening, suspended from a curtain rod extending over the opening, or secured in some other fashion. Examples drawn from the prior art include such as U.S. Pat. No. 7,323,028, U.S. Pat. No. 7,842,116, U.S. Pat. No. 7,416,577, and U.S. Pat. No. 5,370,722, all to Simmons.

### SUMMARY OF THE INVENTION

The present invention is a channel lock construction including two or more modified “U” cross sectional shaped rails which are initially secure in a generally parallel extending fashion proximate to the fascia defined edges of an air intake structure opening and for accomplishing faster and more secure installation of a suitably dimensioned filter screen. The rails are pre-mounted in a first step using a first plurality of screws which install through pre-formed and spaced apart apertures extending along a base surface of each rail abutting an extending fascia edge.

A plurality of bolt head fasteners are provided, such that the enlarged (typically hexagonal shaped) heads are slidably installed within open end located channels establishing the cross sectional configuration of each “U” shaped rail, in such a fashion that the heads either do not rotate within the internal defined channels or pivot out through a forwardly facing and narrowed slot or opening through which the associated threaded shafts are permitted to project. The attachable filter screen is particularly sized for use with a given frame configuration of pre-mounted rails and exhibits a reinforced perimeter within which is configured a plurality of edge extending grommets through which the bolt shafts project upon the screen being applied over the centrally defined intake opening.

Wing nuts are provided for securing over the projecting end portions of the threaded shafts and in order to secure screen flush against the fascia surface perimeter extending around the intake opening. Additional components such as a vinyl coating applied to the internal threads of each wing nut, and/or the application of lock washers, may be provided in order to retain the screen in installed fashion against the intake face and around the opening. In this fashion, the speed of installation of the filter is increased for any piece of mechanical equipment

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the channel lock filter fastening system according to a first embodiment of the present invention and exhibiting a single pair of upper and lower horizontal extending and fascia supporting rails to which the filter screen is secured by the associated bolt fasteners;

FIG. 2 is a view similar to FIG. 1 of a system according to a second embodiment with first horizontal and second vertical pairs of intake face mounted rails;

FIG. 3 is a side cutaway view in exploded fashion of a pre-assembly location of a selected bolt fastener, rail location, screen with reinforced edge located grommet, washer and wing nut;

FIG. 4 is a succeeding assembly location of the components depicted in FIG. 3;

FIG. 5 is a perspective illustration of an initial pre-assembly step including the installation of a plurality of bolt head fasteners into the modified “U” shaped and fascia attachable rails with threaded shafts projecting through an outwardly facing narrowed slot; and

FIG. 6 is a succeeding assembly stage to FIG. 5 in which the perimeter edge extending filter screen grommets are seated upon the projecting shafts and at which the washers and wing nuts are attached.

### DETAILED DESCRIPTION OF THE PREFERRED EMBODIMENTS

As will be further described with reference to the succeeding illustrations, the present invention discloses a channel lock construction applied to a surrounding fascia associated with an air intake opening. As will be explained in further detail, the present invention enables attachment, of either a single or dual pairs of inner channel defining rails to the face of air handling mechanical equipment using fewer fasteners and as opposed to fastening the filter directly to the face of the unit using other forms of twist lock, toggle, stud adaptor or other types of fasteners, this facilitating faster installation and removal of a flexible filter screen.

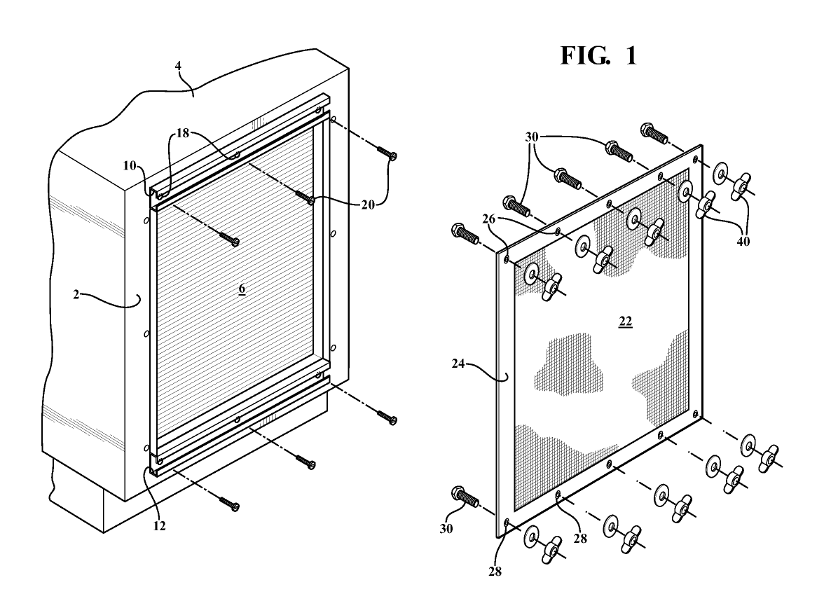

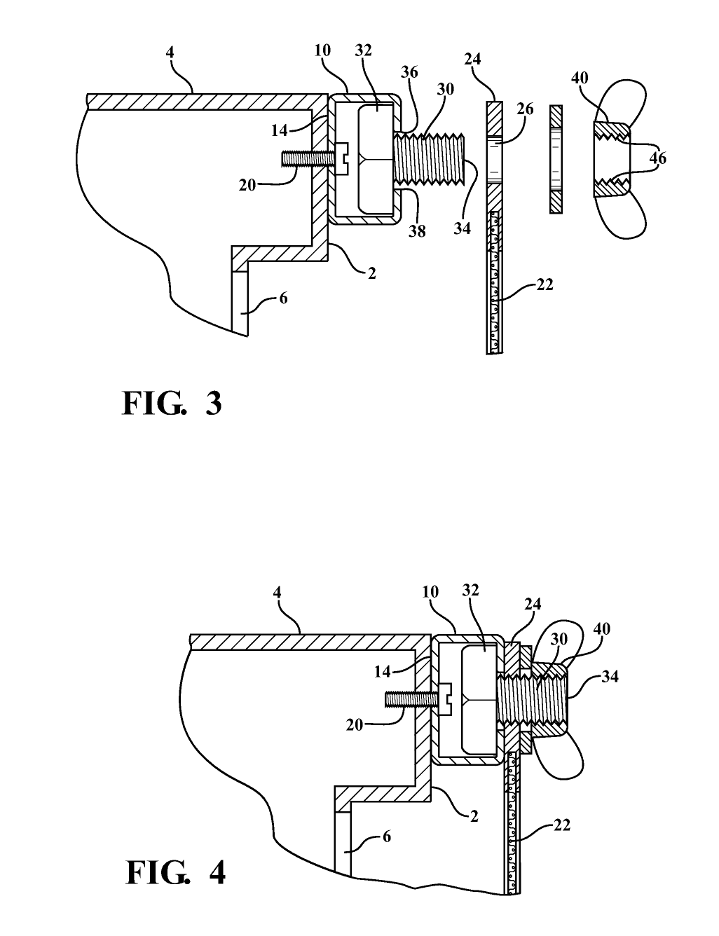

Referring to FIG. 1, an exploded view is generally depicted of the channel lock filter fastening system according to a first embodiment of the present invention and exhibiting a single pair of upper and lower horizontal extending and fascia supporting rails, see at 10 and 12, which are secured at extending locations along a fascia surface 2 associated with an air intake structure 4 (such further understood to include any suitable type of air handling mechanical equipment not limited to air conditioner condenser units, cooling towers etc.). As further depicted in each of succeeding views FIGS. 3-6, each of the rails (see for example first upper horizontal extending rail 10) exhibits a three dimensional, and typically modified “U”, shape with a base surface (see at 14 in each of FIGS. 3-6).

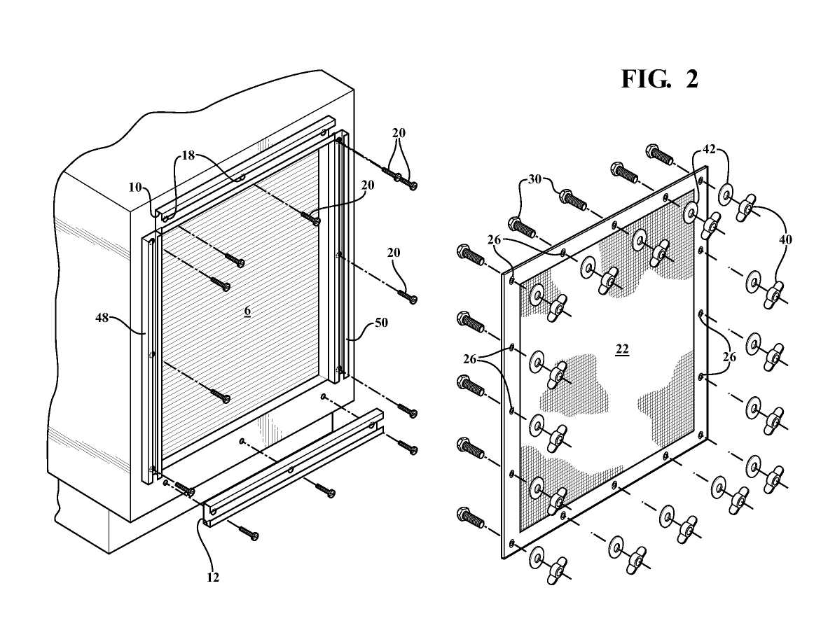

A plurality of spaced apart apertures are defined by inner perimeter extending circular edges 18 (see again rail 10 in each of FIGS. 1 and 2). A plurality of screw fasteners 20 are provided and insert through the circular apertures in order to fasten the rails 10 and 12 in horizontal and parallel extending fashion above and below an intake opening or area which is further generally designated at 6 in each of FIGS. 1-4.

A filter screen 22 is provided, typically exhibiting a flexible mesh like material and including a surrounding reinforced outer portion 24. First 26 and second 28 pluralities of grommets (such interpreted to include metal ringlets or the like which are molded, press fit or otherwise affixed), extend along top and bottom outer hem extending locations of the reinforced outer portion 24.

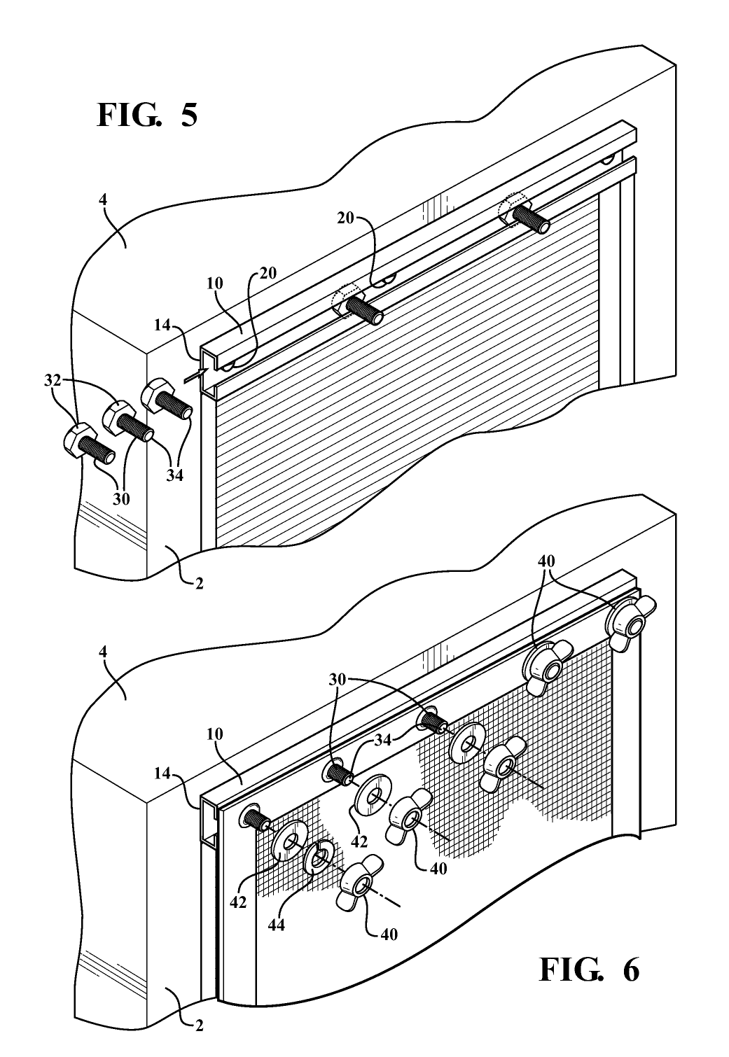

A plurality of bolt fasteners 30 are provided and are identical in construction as with the various edge extending grommets or screw fasteners. As best shown in FIGS. 3-6, an enlarged head 32 (typically hexagonal shaped) is dimensioned so that it establishes a minor degree of clearance with the inner extending edges of the associated channel defined in the selected rail 10. This facilitates the bolts 30 to be successively installed through an open accessible end of the rail 10 (see FIG. 5) and traversable along the channel interior to desired intermediate locations, and with an end 34 of each bolt shaft projecting beyond a slot (see walls 36 and 38 in partially exploded view of FIG. 3) defined in a forward spaced projecting edge of the rail.

At this point, and viewing FIGS. 1, 4 and 6 collectively, the filter screen 22 is applied such that the ringlets 26 are successively seated over the projecting shaft ends 34, following which a plurality of nuts, by non-limiting example depicted as wing nuts 40, are applied over the exposed shaft ends and are rotated into a tightening arrangement in order to secure the filter screen to the rails 10 and 12. Also depicted are a plurality of washers 42 (see FIG. 6) this also contemplating the additional or alternate use of lock washers (further at 44 in FIG. 6) and so as to prevent the filter from becoming inadvertently loosened from the intake structure fascia.

Alternative to separately provided washers/lock washers, it is also envisioned that suitable washer/lock washer portions can be integrally formed into the wing nut (or other nut) construction. It is further envisioned that, referring to FIG. 3, a suitable nylon coating 46 can be applied to the inner threads associated with each wing nut 40 and which can be accomplished both in combination or alternate the incorporation of any type of separately utilized or integrally formed lock washers. It is further understood that the configuration and dimensioning of the enlarged bolt heads is such that, during twisting application of the nuts 40, the heads 32 do not turn or rotate within the channels (see again FIGS. 3 and 4), such otherwise impeding the ability to quickly apply or remove the nuts 40.

FIG. 2 is a view similar to FIG. 1 of a system according to a second embodiment which differs only to the extent that it adds a second vertical pair of intake face mounted rails 48 and 50 applied to opposite and vertically extending sides of the fascia 2 in such a fashion that the first (10 and 12) and second pairs (48 and 50) of rails collectively establish a generally rectangular shape (this including a square shape in the instance in which the sides of the intake opening and the lengths of all the rails are co-equal). Otherwise, the filter 22 is as previously disclosed in claim 1 with the corresponding modification to include additional grommets 26 likewise extending along the vertical side edges of the reinforced outer frame (also hem or skirt) with corresponding additional bolts 30, wing nuts 40 and washers 42 likewise being provided so as to progressively secure the filter 22 along each of four interconnecting edges and as opposed to only two upper and lower edges as is the case in the illustration of FIG. 1. Such an assembly option as depicted in FIG. 2 contemplates, without limitation, that the bolts, nuts and washers associated with the upper rail 10 are first assembled, following which the sides 48 and 50 are progressively assembled such as further by individually supporting the bolts within the vertical channels during progressive assembly of the nuts and washers. That said, the present invention does not preclude or limit any particular assembly protocol or sequence beyond that which is possible owing to the structural aspects of the design.

Having described my invention, other and additional preferred embodiments will become apparent to those skilled in the art to which it pertains and without deviating from the scope of the appended claims.

I claim:

1. A fastening system for applying, over an intake opening and surrounding fascia of a structure, a filter screen exhibiting a reinforced extending perimeter within which is configured a plurality of grommets, said fastening system comprising:
at least one elongated rail adapted to being secured to the fascia in extending fashion proximate the intake opening, said rail exhibiting a three dimensional cross sectional shape with a forwardly projecting support surface within which is configured an outwardly facing narrowed slot;
a plurality of bolt head fasteners installable through an accessible end location of said rail and traversable along an interior channel defined in said rail, a threaded shaft of each bolt fastener projecting through said outwardly facing slot; and
upon said grommets aligning with and seating over said projecting shafts, a plurality of nuts being tightened over exposed ends of said threaded shafts in order to affix said filter.

2. The fastening system as described in claim 1, further comprising a pair of rails in parallel and horizontally extending fashion along fascia locations of the structure above and below the intake opening.

3. The fastening system as described in claim 2, further comprising a second pair of rails in parallel and vertically extending fashion along additional fascia locations of the structure at opposite sides of the intake opening and such that said rails are arranged in a generally rectangular configuration.

4. The fastening system as described in claim 1, said rail further comprising a modified “U” shape in cross section.

5. The fastening system as described in claim 1, further comprising a plurality of spaced apart apertures defined in a base surface of said rail through which are installed a plurality of screw fasteners.

6. The fastening system as described in 1, said plurality of nuts further comprising wing nuts.

7. The fastening system as described in claim 5, further comprising a vinyl coating applied to internal threads associated with said nuts.

8. The fastening system as described in claim 1, further comprising a plurality of lock washers installed over said threaded shafts subsequent to seating said filter grommets and prior to application of said nuts.

9. A fastening system for applying, over an intake opening and surrounding fascia of a structure, a filter screen exhibiting a reinforced extending perimeter within which is configured a plurality of grommets, said fastening system comprising:
a pair of rails arranged in parallel and horizontally extending fashion along fascia locations of the structure above and below the intake opening, each of said rails exhibiting a modified “U” shaped cross sectional shape with a forwardly projecting support surface within which is configured an outwardly facing narrowed slot;
a plurality of spaced apart apertures defined in a base surface of each rail through which are installed a plurality of screw fasteners;
a plurality of bolt head fasteners installable through an accessible end location of said rail and traversable along an interior channel defined in said rail, a threaded shaft of each bolt fastener projecting through said outwardly facing slot; and
upon said grommets aligning with and seating over said projecting shafts, a plurality of nuts being tightened over exposed ends of said threaded shafts in order to affix said filter.

10. The fastening system as described in claim 9, further comprising a second pair of rails in parallel and vertically extending fashion along additional fascia locations of the structure at opposite sides of the intake opening and such that said rails are arranged in a generally rectangular configuration.

11. The fastening system as described in 9, said plurality of nuts further comprising wing nuts.

12. The fastening system as described in claim 11, further comprising a vinyl coating applied to internal threads associated with said nuts.

13. The fastening system as described in claim 9, further comprising a plurality of lock washers installed over said threaded shafts subsequent to seating said filter grommets and prior to application of said nuts.

14. A fastening system for applying, over an intake opening and surrounding fascia of a structure, a filter screen exhibiting a reinforced extending perimeter within which is configured a plurality of grommets, said fastening system comprising:
a pair of rails arranged in parallel and horizontally extending fashion along fascia locations of the structure above and below the intake opening, each of said rails exhibiting a modified “U” shaped cross sectional shape with a forwardly projecting support surface within which is configured an outwardly facing narrowed slot;
a second pair of rails in parallel and vertically extending fashion along additional fascia locations of the structure at opposite sides of the intake opening and such that said rails are arranged in a generally rectangular configuration;
a plurality of spaced apart apertures defined in a base surface of each rail through which are installed a plurality of screw fasteners;
a plurality of bolt head fasteners installable through an accessible end location of said rail and traversable along an interior channel defined in said rail, a threaded shaft of each bolt fastener projecting through said outwardly facing slot; and
upon said grommets aligning with and seating over said projecting shafts, a plurality of nuts being tightened over exposed ends of said threaded shafts in order to affix said filter.

15. The fastening system as described in 14, said plurality of nuts further comprising wing nuts.

16. The fastening system as described in claim 15, further comprising a vinyl coating applied to internal threads associated with said nuts.

17. The fastening system as described in claim 14, further comprising a plurality of lock washers installed over said threaded shafts subsequent to seating said filter grommets and prior to application of said nuts.
